(19) United States
(12) Patent Application Publication
(10) Pub. No.: US 2025/0064055 A1
(43) Pub. Date: Feb. 27, 2025

(54) SOLID EFFERVESCENT COMPOSITION COMPRISING ANTIMICROBIAL

(71) Applicant: 3M INNOVATIVE PROPERTIES COMPANY, St. Paul, MN (US)

(72) Inventors: Yifan Zhang, Woodbury, MN (US); Narina Stepanova, Woodbury, MN (US); Lylien Zhang, South St. Paul, MN (US); Yinshi Jin, Gyeonggi-do (KR)

(21) Appl. No.: 18/787,141

(22) Filed: Jul. 29, 2024

Related U.S. Application Data
(60) Provisional application No. 63/534,242, filed on Aug. 23, 2023.

(51) Int. Cl. A01N 25/18; A01N 25/10; A01N 25/34; A01N 31/02

(52) U.S. Cl. CPC A01N 25/18; A01N 25/10; A01N 25/34; A01N 31/02

(57) ABSTRACT

A solid effervescent cleaning composition is described comprising one or more acids and a gas generator; wherein a 1 wt. % aqueous solution of the solid cleaning composition has a pH in a range of 4 to 9; and at least one antimicrobial compound. In some embodiments, a 1 wt. % aqueous solution of the solid effervescent cleaning composition provides at least a 3 log reduction for both gram position and gram negative bacteria. In some embodiments, the antimicrobial compound is selected from aromatic alcohols; aliphatic alcohols, optionally further comprising an ester moiety; and combinations thereof. Also described is a (e.g. dry) wipe comprising a woven or nonwoven substrate further comprising the solid effervescent cleaning composition described herein; and cleaning tools with handles.

### SUMMARY

Although various acid-based (e.g. solid effervescence) cleaning compositions are known, it has been discovered that only highly acidic compositions provide effective antimicrobial activity of both gram (−), (e.g. E. coli) and gram (+), (e.g. S. aureus) bacteria. Less acidic compositions, having a pH in the range of 4 to 6 do not provide effective antimicrobial activity of gram (−) microbes, (e.g. E. coli). Less acidic cleaning compositions can be desired because such compositions are less corrosive. Thus, industry would find advantage in less acidic cleaning compositions that provide effective antimicrobial activity with respect to both gram negative and positive bacteria.

In one embodiment, a solid effervescent cleaning composition is described comprising: one or more acids and a gas generator; wherein a 1 wt. % aqueous solution of the solid cleaning composition has a pH in a range of 4 to 9; and at least one antimicrobial compound. In some embodiments, a 1 wt. % aqueous solution of the solid effervescent cleaning composition provides at least a 3 log reduction for both gram position and gram negative bacteria. In some embodiments, the antimicrobial compound is selected from aromatic alcohols; aliphatic alcohols, optionally further comprising an ester moiety; and combinations thereof.

The solid effervescent cleaning composition may be a powder optionally provided in a water-soluble pouch or pod; or a solid mass such as a tablet.

Also described is a (e.g. dry) wipe comprising a woven or nonwoven substrate further comprising the solid effervescent cleaning composition described herein.

The solid effervescent cleaning composition or (e.g. woven or nonwoven) substrate comprising such solid effervescent cleaning composition may be attached to handle.

### DETAILED DESCRIPTION

The present invention is a solid effervescent cleaning composition including powder or tablets. In some embodiments, the solid effervescent cleaning composition can be compressed (e.g. molded under pressure) into a solid article (e.g. table) at room and low temperatures. In other embodiments, the powder can be provided in a premeasured pouch or pod of water-soluble (e.g. polyvinyl alcohol) film. The composition provides effervescence, foaming, and acidity after being dissolved in water.

### Acid

The solid effervescent cleaning composition comprises one or more acid. The acid(s) function as both an effervescent agent and a cleaning agent. The reaction of the acid(s) with the gas generator provides foaming. In some embodiments, the acid can also provide antimicrobial activity with respect to gram (+), (e.g. S. aureus) bacteria.

The cleaning composition typically comprises a weak acid, optionally in combination with a strong acid.

A weak acid is defined as an acid having a pKa of between about 2.5 and about 5. The weak acid can contribute to increased tablet strength. In one embodiment, the weak acid is a carboxylic acid. Examples of suitable weak acids include, but are not limited to: formic acid, acetic acid, propionic acid, butyric acid, lactic acid, sorbic acid, fumaric acid, malic acid, tartaric acid, citric acid, benzoic acid, adipic acid, ascorbic acid, and glycolic acid.

A strong acid is defined as an acid having a pKa of between about −3 and about 2. The strong acid functions to provide quick foaming and is generally less hydroscopic. In one embodiment, the strong acid can also perform a disinfecting function. In one embodiment, the strong acid is one of an alkyl sulfonic acid, an aryl sulfonic acid, and oxalic acid. Examples of suitable alkyl sulfonic acids and aryl sulfonic acids include, but are not limited to: sulfamic acid, p-toluenesulfonic acid, and methanesulfonic acid.

The solid effervescent cleaning composition typically comprises at least 35, 36, 37, 38, 39, 40, 41, 42, 43, 44, or 45 wt. % of one or more weak acids, such as citric acid. In some embodiments, such as when the solid effervescent cleaning composition comprises low amounts or no strong acid, the amount of weak acid may be at least 50, 55, or 60 wt. %. In some embodiments, The solid effervescent cleaning composition may comprise no greater than 60, 59, 59, 57, 56, 55, 54, 53, 52, 51, or 50 wt. % of one or more weak acids, such as citric acid.

In some embodiments, the solid effervescent cleaning composition further comprises a strong acid, such as sulfamic acid in an amount of at least 5, 6, 7, 8, 9, 10, 11, 12, 13, 14 or 15 wt. % of the total solid effervescent cleaning composition. In some embodiments, the amount of strong acid, such as sulfamic acid, is no greater than 20, 19, 18, 17, 16, 15, 14, 13, 12, 11, or 10 wt. % of the total solid effervescent cleaning composition. In some embodiments, the amount of strong acid, such as sulfamic acid, is less than 10, 9, 8, 7, 6, 5, 4, 3, 2, or 1 wt. % of the total solid effervescent cleaning composition.

When a strong acid, such as sulfamic acid, is present, the amount of weak acid(s) is greater than the amount of strong acid(s). In some embodiments, the weight ratio of the weak acid(s) to the strong acids ranges from is at least 1.75:1; 2:1, 3:1, 4:1, 5:1, 6:1, 7:1, 8:1, 9:1 or 10:1.

The composition has an acidic pH, making it favorable to cleaning surfaces, such as a toilet bowl. Hard water stains and lime scales can be dissolved under acidic conditions. In typical embodiments, the composition has a pH of at least 4 and typically no greater than 6 or 5.5.

The pH of the cleaning composition is a function of the selection of acids, the concentration of the acids, the selection and amount of gas generator, and the concentration of water the solid cleaning concentration is added to (e.g. dissolved in).

A 1 wt. % aqueous solution of the solid effervescent cleaning composition has a pH of at least 4 and typically no greater than 9, 8.5, 8, 7.5, 7, or 6.5. In some embodiments, a 1 wt. % aqueous solution of the solid effervescent cleaning composition has a pH no greater than 6 or 5.5.

In one embodiment, the solid effervescent cleaning composition when added to water can remove at least about 25%, at least about 50%, at least about 60%, at least about 70%, at least about 80%, at least about 90%, at least about 95% of hard water stains. In one embodiment, the composition can remove at least about 25%, at least about 50%, at least about 60%, at least about 70%, at least about 80%, at least about 90%, at least about 95% of lime scale.

### Gas Generator

The solid effervescent cleaning composition comprises a gas generator. The gas generator functions as an effervescent agent to create foam/bubbles. The gas generator is a basic component that interacts with the acid in the composition to provide effervescence. Examples of suitable gas generators include, for example, carbon dioxide generators and oxygen generators. Examples of suitable carbon dioxide generators include, but are not limited to: bicarbonate salts of Group I metals, of Group II metals and of other cations, including ammonium, alkyl (mono-, di-, or tri-) ammonium, or those of transition metals; carbonate salts of Group I metals, of Group II metals, and of other cations, including ammonium, alkyl (mono-, di-, or tri-) ammonium, or those of transition metals; and percarbonate salts of Group I metals, of Group II metals, and of other cations, including ammonium, alkyl (mono-, di-, or tri-) ammonium, or those of transition metals. Examples of carbon dioxide generators include, for example, sodium carbonate, sodium bicarbonate, potassium carbonate, potassium bicarbonate, and calcium bicarbonate.

In order to produce maximum foam in the effervescent system of the composition, the normality ratio of acid and base in the composition is typically about 1. The normality ratio is defined as the equivalent moles of acidic functionality vs. the equivalent mole of basic functionality in the formulations. As the ratio deviates from 1, the total amount of foam in the system will decrease accordingly. In one embodiment, the composition has an acid to base ratio of between about 10:1 and about 1:10, particularly between about 5:1 and about 1:5, and more particularly between about 3:1 and about 1:3.

Examples of suitable oxygen generators include, but are not limited to: hydrogen peroxide; peracetic acid generated from sodium percarbonate/TAED (tetraacetylethylenediamine); percarbonate salts of Group I metals, of Group II metals and of other cations, including ammonium, alkyl (mono-, di-, or tri-) ammonium, or those of transition metals; chlorate and perchlorate salts of Group I metals, of Group II metals and of other cations, including ammonium, alkyl (mono-, di-, or tri-) ammonium, or those of transition metals; superoxide salts of Group I metals, of Group II metals and of other cations, including ammonium, alkyl (mono-, di-, ortri-) ammonium, or those of transition metals; and peroxide salts of Group I metals, of Group II metals and of other cations, including ammonium, alkyl (mono-, di-, ortri-) ammonium, or those of transition metals.

The foaming allows the composition to contact hard to reach surfaces, such as the underside of the inner surface of a toilet bowl. In one embodiment, with 40 g samples in 2 liters of water, a sufficient amount of foam is produced to have a foam height of at least about 0.1 cm, at least about 0.5 cm, at least about 0.75 cm, at least about 1 cm, at least about 1.25 cm, at least about 1.5 cm, at least about 1.75 cm, at least about 2 cm, at least about 3.0 cm, and at least about 3.5 cm after a one to five minute duration once the sample tablet is submerged in water. The foam height can be measured by adding 2000 grams of room temperature deionized water into a 4-liter beaker, followed by adding a 40 grams of the solid effervescent cleaning composition (i.e. a 2 wt. % solution). The height of the foam of the effervescent tablet can be measured and recorded as it dissolves after various duration of time such as 15 seconds, 30 second, 1 minute, two minutes, three minutes, and five minutes.

### Antimicrobial Compound

The solid effervescent cleaning composition comprises a gas generator at last one antimicrobial compound provides at least part of the antimicrobial activity. In typical embodiments, a 1 wt. % aqueous solution of the solid effervescent cleaning composition provides at least a 3 log reduction for both gram position and gram negative bacteria. Acid can provide at least part of the antimicrobial activity. When the cleaning composition is sufficiently acidic, the acid alone can provide sufficient antimicrobial activity with respect to gram positive bacteria. However, in the absence of the antimicrobial compound a 1 wt. % aqueous solution of the solid effervescent cleaning composition does not provides at least a 3 log reduction for gram negative bacteria. When the solid effervescent cleaning composition is less acidic, neutral, or basic, the antimicrobial compound alone may provide at least a 3 log reduction for both gram position and gram negative bacteria for a 1 wt. % aqueous solution.

In some embodiments, the antimicrobial compound is an aromatic alcohol including phenolic compounds such as thymol, carcacrol, eugenol, and natural oils containing phenolic compounds such as thyme oil and clove oil.

In some embodiments, the antimicrobial compound is an aliphatic alcohol such as a (C5-C12)1,2-saturated alkanediol, and/or (C12-C18)1,2-unsaturated alkanediol. Examples include 1,2 hexane diol, 1,2 octanediol, 1,2 decane diol, 1,2 oleyl diol and mixtures thereof.

In another embodiment, the aliphatic alcohol may further comprise a contiguous ester moiety. In this embodiment, the aliphatic alcohol may be characterized as a fatty acid ester of a polyhydric alcohol. Such aliphatic alcohols may have the formula (R¹—C(O)—O)ₙ—R², wherein R¹ is the residue of a (C8-C12) saturated fatty acid, or a (C12-C22) unsaturated, including polyunsaturated fatty acid, R² is the residue of a polyhydric alcohol (typically and preferably, glycerin, propylene glycol, and sucrose, although others can be used including pentaerythritol, sorbitol, mannitol, xylitol, etc.), and n=1 or 2. The R² group includes at least one free hydroxyl group (preferably, residues of glycerin, propylene glycol, or sucrose). Preferred fatty acid esters of polyhydric alcohols are esters derived from (C8-C12) saturated fatty acids. For embodiments in which the polyhydric alcohol is glycerin or propylene glycol, n=1, although when it is sucrose, n=1 or 2.

Exemplary fatty acid monoesters include, but are not limited to, glycerol monoesters of lauric (monolaurin), caprylic (monocaprylin), and capric (monocaprin) acid, and propylene glycol monoesters of lauric, caprylic, and capric acid, as well as lauric, caprylic, and capric acid monoesters of sucrose. Other fatty acid monoesters include glycerin and propylene glycol monoesters of oleic (18:1), linoleic (18:2), linolenic (18:3), and arachonic (20:4) unsaturated (including polyunsaturated) fatty acids. As is generally known, 18:1, for example, means the compound has 18 carbon atoms and 1 carbon-carbon double bond.

In some embodiments, the desired antimicrobial lipid is liquid when in neat form (i.e., not mixed with a solvent) at room temperature (23° C.).

In some embodiments, the total amount of a antimicrobial compound(s) is at least 1, 2, 3, 4, or 5 wt. %, based on the total solid effervescent cleaning composition. In some embodiments, the total amount of antimicrobial compound(s) is no greater than 20, 15 or 10 wt. %, based on the total solid effervescent cleaning composition. The solid effervescent cleaning composition typically comprises one or more antimicrobial compound in the least amount to provide the desired antimicrobial activity when the composition is diluted in water. In some embodiments, the solid effervescent cleaning composition comprises at least 2, 3, 4, or 5 wt. % of a single phenolic compound (e.g. thymol) or a single fatty acid monoester.

In other embodiments, the solid effervescent cleaning composition comprises at least 2, 3, 4, or 5 wt. % of a phenolic compound (e.g. thymol) in combination with at least 0.25, 0.5, 1, 2, 3, 4, or 5 wt. % of an aliphatic alcohol and/or a fatty acid monoester.

In some embodiments, the antimicrobial compound has low solubility in water, i.e. no greater than 10 grams per 1000 grams (1.0 liter) of deionized water. Solubility in water of various compounds, including antimicrobial compounds, is often known (e.g. reported by a supplier). Solubilities can also be determined using radiolabeled compounds as described under “Conventional Solubility Estimations” in Solubility of Long-Chain Fatty Acids in Phosphate Buffer at pH 7.4, Henrik Vorum et al., in Biochimica et. Biophysica Acta., 1126, 135-142 (1992).

It has been found that the presence of antimicrobial compounds that have low water solubility (e.g. insoluble oils), does not hinder the effervescent and foam formation of the cleaning composition. This is surprising since insoluble oils are known anti-foaming agents.

In typical embodiments, the acid and antimicrobial compounds described herein are the only biocides in the composition. In such embodiment, the composition does not comprise other biocides such as benzalkonium chloride, sodium dichloroisocyanurate, benzisothiazolinone chlorhexidine, quaternary ammonium derivatives, and combinations thereof.

The solid effervescent cleaning composition combined with water can be used to provide effective antimicrobial activity to a (e.g. hard) surface. Compositions can be used in methods under conditions effective to kill or inactivate one or more microorganisms, such as bacteria, fungi, and viruses. In certain embodiments, the compositions provide antimicrobial kill of both gram positive and gram negative bacteria according to the Antimicrobial Efficacy Test (exemplified in the Examples Section).

In certain embodiments, the solid effervescent cleaning composition combined with water provides at least 3, 4, 5, or 6 log reduction in test bacteria for both gram positive and gram negative bacteria when evaluated by the Antimicrobial Efficacy Test exemplified in the Examples Section. Such antimicrobial activity can be achieved in 1, 2, 5, or 10 minutes.

Gram positive and gram negative bacteria include for example E. coli, Staphylococcus spp., Streptococcus spp., Pseudomonas spp., Enterococcus spp., and Esherichia spp., Aspergillus spp., Fusarium spp. Candida spp., food pathogens such as Listeria sp., Listeria monocytogenes, Camphylobacter sp., Clostridium sp., Salmonella sp., as well as combinations thereof.

Other relevant organisms include viruses such as herpes virus, rhinovirus, human corona virus, and influenza, Particularly virulent organisms include Staphylococcus aureus (including resistant strains such as Methicillin Resistant Staphylococcus Aureus (MRSA), Staphylococcus epidermidis, Streptococcus pneumoniae, Enterococcus faecalis, Vancomycin Resistant Enterococcus (VRE), Pseudomonas auerginosa, Escherichia coli, Aspergillus niger, Aspergillus fumigatus, Aspergillus clavatus, Fusarium solani, Fusarium oxysporum, Fusarium chlamydosporum, Candida albicans, Candida glabrata, Candida krusei, and combinations thereof. The solid effervescent cleaning composition combined with water is particularly effective for killing or inactivating bacteria such as Staphylococcus aureus and Escherichia coli.

### Optional Water-Soluble Acrylic Polymer

In some embodiments, the solid effervescent cleaning composition further comprises a (e.g. water-soluble) acrylic-based polymer. The acrylic-based polymer is preferably hydrophilic and was discovered to provide significant anti-fouling properties to a surface with the effervescent composition described herein. Such properties can prevent microorganisms from re-attaching to a freshly cleaned surface. In a preferred embodiment, the acrylic-based polymer is a copolymer of vinyl pyrrodine and dimethylaminoethyl methacrylate. In some embodiments, the acrylic-based copolymer includes a hydrophilic acrylic-based copolymer such as polyacrylamide acrylic acid.

Acrylic-based copolymers useful in the provided cleaning compositions are available under the trade designation MIRAPOL from Solvay, S.A., Neder-Over-Heembeek, Brussels, Belgium, MIHAPOL from Miwon Specialty Chemical Co., Ltd., and SOREZ from Ashland Global Specialty Chemicals Inc., Wilmington, DE.

When present, the solid effervescent cleaning composition typically comprises the water soluble copolymer of acrylic acid and acrylamide in an amount of at least 0.5, 1, 2, 3, 4 or 5 wt. % solids. In some embodiments, the amount of water soluble copolymer of acrylic acid and acrylamide is no greater than 20, 15, 10, 9, 8, 7, 6, or 5 wt. % solids.

### Binders

The solid effervescent cleaning composition typically comprises an inorganic binder, an organic binder, or combination thereof. The inorganic and organic binders function to chemically and/or physically hold the components of the composition together.

In some embodiments, inorganic binder reacts with water to cause the composition to harden. The hardened inorganic binder provides structural support to the composition and makes it resistant to deterioration caused by water.

Examples suitable reactive inorganic binders include, but are not limited to: calcium sulfate hemihydrate (e.g. plaster), anhydrous calcium sulfate, sodium silicate, sodium metasilicate, potassium silicate, potassium metasilicate, lithium metasilicate, lithium silicate, cement, and combinations thereof. An example of a particularly suitable reactive inorganic binder includes, but is not limited to, formulated binder compositions based on calcium sulfate hemihydrate, such as DURABOND 20, DURABOND 45, and DURABOND 90 available from USG, located in Chicago, IL.

The solid effervescent cleaning composition typically comprises at least 0.1, 0.5 or 1 wt. % inorganic binder based on the total solid cleaning composition. The amount of inorganic binder is typically no greater than 30, 25, 20, 15, 10 or 5 wt. %.

The composition may comprise an organic binder. The organic binder may improve the overall strength of compressed powders, such as tablets.

Examples of suitable organic binders include, but are not limited to: sugars (such as glucose, fructose, galactose, sucrose, lactose, maltose, and liquid glucose), organic acid salts (such as sodium acetate, calcium acetate, sodium propanoate, sodium glycolate, and sodium citrate), polymers (such as hydroxypropyl cellulose, methyl cellulose, ethyl cellulose, hydroxy propyl methyl cellulose, sodium carboxy methyl cellulose, gelatin, gum arabic chitosan, alginic acid, starch (e.g. corn starch), polyvinylpyrrolidone, polyvinyl alcohol, polyethylene glycol, acrylate polymers, polyurethane, styrene-butadiene rubber, polyester, polyamide, polyethylenimine, vinyl polymer), and combinations thereof. An example of a particularly suitable organic binder includes polyethylene glycol, and particularly a low molecular weight polyethylene glycol. Examples of particularly suitable polyethylene glycols include polyethylene glycols having an average molecular weight range of less than about 20,000 g/mol, particularly between about 400 g/mol and about 10,000 g/mol, and more particularly between about 4,000 g/mol and about 6,000 g/mol. The average molecular weight of the solid polyethylene glycol allows the polyethylene glycol to dissolve quickly in water. As used herein, “molecular weight” refers to weight average molecular weight, as measured using standard gel permeation chromatography methods known in the art.

The solid effervescent cleaning composition may comprise at least 0.1, 0.5 or 1 wt. % organic binder based on the total solid effervescent cleaning composition. In typical embodiments, the amount of organic binder is at last 2, 3, 4, 5, 6, 7, 8, 9, or 10 wt. % of the total solid cleaning composition. The amount of organic binder is typically no greater than 30, 25, 20 wt. %.

### Surfactants

The solid effervescent cleaning composition typically comprises one or more surfactants.

The term “surfactant” as used herein describes molecules with hydrophilic (polar) and hydrophobic (non-polar) segments on the same molecule, and which are capable of reducing the surface tension of the composition. Surfactants can be classified by the presence of formally charged groups in its head. The head of an ionic (e.g. anionic or cationic) surfactant carries a net charge. A non-ionic surfactant has no charged groups in its head.

The molecular weight of the surfactant(s) is typically at least 150 g/mole and generally no greater than 500 or 600 g/mole. In some embodiments, the molecular weight of the surfactant is at least 200 g/mole, 250 g/mole, or 300 g/mole.

Anionic surfactants contain anionic (i.e. negatively charged) functional groups at their head, such as sulfate, sulfonate, phosphate, and carboxylates in combination with a positively charged counterion.

Suitable anionic surfactants are preferably C₆-C₁₈-alkylbenzenesulfonates, C₆-C₂₀-alkyl sulfonates, C₆-C₁₈-monoalkyl sulfates, C₆-C₁₈-alkyl polyglycol ether sulfates having from 2 to 6 ethylene oxide units (EO) in the ether moiety, and mono- and di-C₆-C₁₈-alkyl sulfosuccinates. In addition, it is also possible to use C₆-C₁₈-α-olefinsulfonates (also described as alphasulpho esters), sulfonated C₆-C₁₈ fatty acids, in particular dodecylbenzenesulfonate, C₆-C₂₂ carboxamide ether sulfates, C₆-C₁₈-alkyl polyglycol ether carboxylates, C₆-C₁₈N-acyltaurides, C₈-C₁₈ N-sarcosinates and C₆-C₁₈-alkyl isethionates and mixtures thereof. Specific examples include dodecylbenzenesulfonate, dioctyl ester of sodium sulfosuccinic acid, and polyethoxylated alkyl (C₁₂) ether sulfate.

The anionic surfactants are typically in the form of sodium salts, but may also be present in the form of other alkali metal or alkaline earth metal salts, for example magnesium salts, and in the form of ammonium or mono-, di-, tri- or tetraalkylammonium salts, in the case of the sulfonates, the anionic surfactant may also in the form of their corresponding acid, for example dodecylbenzenesulfonic acid.

In some embodiments the anionic surfactant has the general formula R¹OSO₃⁻X⁺ wherein R¹ is a C₈-C₂₀ alkyl or alkenyl group and X is an alkali metal or alkaline earth metal such as sodium or potassium. One common aliphatic sulfate salt is depicted as follows:

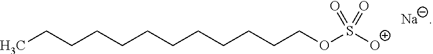

In some embodiments, the concentration of anionic surfactant is at least 0.2, 0.3, 0.4, 0.5, 0.6, 0.7, 0.8, 0.9 or 1 weight %. In some embodiments, the concentration of anionic surfactant is no greater than 15, 14, 13, 12, 11, 10, 9, 8, 7, 6, 5, or 4 weight %. In some embodiments, the concentration of anionic surfactant is no greater than 3 or 2 weight %.

The composition may optionally comprise at least one non-ionic surfactant. Nonionic surfactants have no ions and thus have no electric charge. Nonionic surfactants typically derive their polarity from having a (e.g. oxygen-rich) polar portion of the molecule at one end and a large organic molecule (e.g. alkyl or alkenyl group containing from 6 to 30 carbon atoms) at the other end. The oxygen component is usually derived from short polymers of ethylene oxide or propylene oxide. Nonionic surfactants include for example alkyl polysaccharides, amine oxides, fatty alcohol ethoxylates, alkyl phenol ethoxylates, and ethylene oxide/propylene oxide block copolymers. Some nonionic surfactants such as alkyl pyrrolidinone and ethylene glycol monohexyl ether also reduce streaking on (e.g. glass) surfaces. Various nonionic surfactants are commercially available such as from Huntsman under the trade designation “Surfonic”.

### Additives

Other additives can be included in the composition to perform various functions. Examples include, but are not limited to: chelating agents, surfactants, oxidizers, anti-caking agents, hydrophilic agents, dispersants, co-binders, processing aids, fillers/tougheners, softeners, abrasive particles, desiccants, mold release agents, lubricants, disintegrants, cleaning agents, coupling agents, photoinitiators, thermal initiators, viscosity modifiers, adhesion promoters, grinding aids, wetting agents, dispersing agents, light stabilizers, antioxidants, coloring agents, dyes, pigments, and fragrances, anti-caking agents, dispersants.

In some embodiments, the solid effervescent cleaning composition is a powder. In some embodiments, the powder can be provided in a premeasured pouch or pod of water-soluble (e.g. polyvinyl alcohol) film. When the powder is a premeasured pouch or pod, the pouch or pod may include more than one compartment for separating a portion of the cleaning composition components from others.

In other embodiments, the powder can be compressed (e.g. molded under pressure) into a solid article (e.g. table) at room and low temperatures. After being molded into a condensed, solid-state format, the composition provides adequate mechanical integrity, hardness, toughness, and durability to be used on a hard surface. In one embodiment, the solid-state composition is in the form of a powder, tablet or pod that can be dropped into, for example, a toilet bowl, to provide cleaning. In one embodiment, the composition can be molded into a cleaning head and used in conjunction with a handheld tool. This provides a dissolvable head that functions as a scrubbing tool as well as providing the needed chemicals for cleaning. The solid-state composition thus has dual functionality of being used as a tablet and/or used on a handle. The solid-state composition can also first be used on a handle for cleaning with mechanical force and then released into water for static cleaning.

In some embodiments, the solid, compressed composition has a certain hardness and durability such that it does not immediately dissolve or break apart when it is contacted with water and remains in a solid-state form for an amount of time sufficient to contact and clean a surface.

In one embodiment, when the solid compressed composition has a mass of 40 grams and a diameter of 48 mm (1.0 mm) and a height of 21.0 mm(±1.0 mm) with a recess diameter of 29.8 mm (±1.0 mm) and a recess height of 12.8 mm (±1.0 mm) and is rectangularly shaped with curved comers, then the tablet breaking force is at least about 10 lbf, about 15 lbf, about 20 lbf, and particularly of at least about 25 lbf. In one embodiment, the solid, compressed composition has an aged Shore A hardness of at least about 30, particularly at least about 30, more particularly at least about 50 and about 100, and even more particularly at least about 80. In one embodiment, the solid, compressed composition has an aged Shore D hardness of between about 10 and about 100, and particularly between about 20 and about 70. The amount of time the composition remains in a solid-state form can be measured as dissolution time, defined as the time that a 40-gram solid-state composition takes to disintegrate and dissolve when immersed in 2 liter of water without agitation after the 40-gram solid, compressed composition has been aged in the air at ambient conditions for two weeks. The solid, compressed composition has a dissolution time that is optimal for scrubbing the surface to be cleaned. In one embodiment, the solid, compressed composition has a dissolution time of between about 1 minute and about 60 minutes, particularly between about 5 and about 40 minutes, and particularly between about 10 and about 30 minutes.

To make the solid-state composition, the components are mixed together. If there is a fragrance, the fragrance is mixed with sodium carbonate. The sodium carbonate and fragrance are first mixed, and then mixed with any surfactants to form a pre-mixture, after which the pre-mixture is mixed with the mixture of remaining components. The final mixture of the composition is added into a cavity or mold where mechanical force is applied, for example by a hydraulic or a mechanical press, to compress the mixture into a compressed article. The solid, compressed article can take on any geometry without departing from the intended scope of the present invention. After released from the cavity or mold, the compressed article is aged in the air or in a sealed environment at ambient conditions to allow it to harden over time. In one embodiment, the resulting solid-state composition is compressed to form a tablet. In one embodiment, the solid-state composition is wrapped by a water-soluble polymer film to form a pod.

The solid effervescent cleaning composition combined with water or aqueous liquid during use, such as the water of a toilet bowl. When combined with water or aqueous liquid, an aqueous cleaning composition is formed.

The wt. % solids of the solid effervescent cleaning composition in the water is typically at least 0.5, 0.75, or 1 wt. %. In some embodiments, the wt. % solids of the solid effervescent cleaning composition in the water is no greater than 10, 9, 8, 7, 6, 5, 4, 3, 2 wt. %. As depicted in the forthcoming examples, good cleaning performance and antimicrobial efficacy with respect to both gram positions and grams negative bacteria was obtained with a 1 wt. % aqueous solution of the solid effervescent cleaning composition. However, other concentrations may also be effective.

In some embodiments, the solids effervescent cleaning composition can be dissolved to form as aqueous cleaning composition. The aqueous compositions can be delivered using a variety of techniques. This can be accomplished by spraying, dipping, wiping, dropping, pouring, toweling, or the like, onto the surface area to be treated.

In some embodiments, the aqueous or dry solid cleaning compositions can be delivered from substrates (e.g., woven or knitted cloth, nonwovens, sponges, foams, paper products such as paper towels, towelletes, laminates of one or more of these substrates).

Nonwoven substrates can be made from synthetic, natural, or chemically modified natural materials, or from mixtures thereof. Suitable synthetic materials include, but are not limited to, synthetic organic polymers such as polyolefins (including polyethylenes (LDPE, LLDPE, metallocene polyethylenes and the like), polypropylene, ethylene/propylene copolymers, polybutylene, ethylene copolymers such as ethylenevinyl acetate and ethylene acrylate copolymers, aliphatic and aromatic polyesters including, but not limited to, PET, PETG, polylactic acid, polyhydroxybutyrate, polyhydroxyvalerate, polyethylenesuccinate, and the like; polyamides, polyurethanes, block copolymers such as Kraton polymers, thermoplastic starches, and copolymers and polymer blends. Non-synthetic materials include natural or chemically modified natural materials. Man-made materials include materials that are manufactured from cellulose, either derivative or regenerated. Typical examples of man-made fibers are regenerated viscose rayon and cellulose acetate. Natural fibers include, but are not limited to, wood pulp, cotton, rayon, bamboo, jute, and hemp. The substrate can be prepared by any method known the art. Suitable manufacturing processes for making a nonwoven substrate that may be used in connection with the present invention include, but are not limited to, carding, meltblown, wet laid, air laid, spunbond, hydroentangling, needlepunching, thermal bonding, etc. and combinations thereof. The fibers used for a nonwoven substrate can include fibers of indefinite length (e.g., filaments), fibers of discrete length (e.g., staple fibers), and multifilament yams. The fibers used may also be multicomponent fibers including sheath/core, side by side, and splittable fibers. The substrate can be a single layer or multi-layer construction. The nonwoven substrate can also be an abrasive wipe, such as a nonwoven that has a cured resin or binder printed in a pattern on its surface.

In some embodiments, the solid effervescent cleaning composition is provided as a dry wipe that is not moistened until the time of use. A roll of perforated wipes can be provided in a container to which the user removes one or more wipes and submerges the wipe in water or contacts the wipe with a wet surface prior to use.

In some embodiments, a handle may be attached to the solid effervescent cleaning composition, as previously described, or (e.g. woven or nonwoven) substrate comprising the solid effervescent cleaning composition. The handle typically releases the composition or substrate after use. Various cleaning tools are known. (See for example U.S. Pat. No. 7,530,138).

The invention is illustrated by the following examples. Unless otherwise noted or readily apparent from the context, all parts, percentages, ratios, etc. in the Examples and the rest of the specification are by weight.

### Components of the Examples

| Component/Tradename | Description | Source |
|---|---|---|
| Citric Acid | Anhydrous, 100% | Cargill Inc., |
| | | Wayzata, MN 55391 |
| Sulfamic Acid | 99% | Univar, Downers |
| | | Grove, IL 60515 |
| Soda Ash Gas | Sodium carbonate, | Genesis Alkali, |
| Generator | 100% | Philadelphia, PA 19103 |
| Sodium Bicarbonate | 100% | Church & Dwight, Ewing |
| Gas Generator | | Township, NJ 08628 |
| SZ41894 Fragrance | Citrus Cleanscents | Sozio, Inc., |
| | Fragrance | Piscataway, NJ 08854 |
| Stepanol WA-100 | Sodium Lauryl | Stepan Company, |
| NF/USP | Sulfate | Northfield, IL 60093 |
| Surfactant | | |
| Stepanol Me-Dry | Sodium Lauryl | Stepan Company, |
| Surfactant | Sulfate | Northfield, IL 60093 |
| Lathanol ® LAL | Sodium lauryl | Stepan Company, |
| Surfactant | sulfoacetate | Northfield, IL 60093 |
| Sipernat ® 50 S | Silicon dioxide, | Evonik Corp., |
| Anticaking Agent | chemically prepared | Parsippany, NJ 07054 |
| PEG 400, PEG 6000 | Polyethylene glycol | Dow Chemical, |
| Organic Binder | | Midland, MI 48674 |
| NO. 1 Molding Plaster | Calcium Sulfate | USG, Chicago, |
| Inorganic Binder | Hemihydrate | IL 60661 |
| Blue Dye | Erioglaucine | Clariant Corp., |
| | Disodium Salt | Charlotte, NC 28205 |
| SunFast Green 7 | Green Pigment | Sun Chemical, |
| | | Cincinnati, OH 45232 |
| Jeecide Cap | Caprylyl glycol | Jeen International Corp., |
| Antimicrobial Agent | | FairField, NJ 07004 |
| Thymol Antimicrobial | 2-Isopropyl-5- | Sigma-Aldrich, |
| Agent | methylphenol | St. Louis, MO 63103 |
| | (solubility is water | |
| | 0.9 g/L at 20° C.) | |
| Sodium Benzoate | 99% | Sigma-Aldrich, |
| Perservative | | St. Louis, MO 63103 |
| Sodium Metabisulfite | 99% | Sigma-Aldrich, |
| Perservative | | St. Louis, MO 63103 |
| Mirapol Surf-S 900 | Solid Acrylic | Solvay USA, |
| | Polymer | Princeton, NJ 08540 |
| Corn Starch | Starch | Tate & Lyle, |
| Anticaking Agent | | Decatur, IL 62521 |
| Preventol O Extra | Ortho-phenylphenol | Lanxess Corp., |
| Antimicrobial Agent | | Pittsburg, PA 15275 |
| Capmul 908P | Propylene Glycol | Abitec Corp., |
| Antimicrobial Agent | Monocaprylate | Janesville, WI 53546 |

### Test Methods

### Method 1. Solution Preparation

20 g powder of powder was dissolved in 2-liter water for 10 minutes before antimicrobial test.

### Method 2. Antimicrobial Assay Protocol

An in vitro, time-kill assay was used to determine the effectiveness of the antimicrobial solutions. This test shows the ability of an antimicrobial agent to reduce number of viable cells of the chosen microorganisms during a chosen contact time.

Microorganisms tested in these experiments were E. coli (ATCC 8739) and Staphylococcus aureus (ATCC 6538). Microorganisms were grown on suitable agar and inoculums prepared in Butterfield's phosphate buffer with an optical cell density of approximately 3.0 McFarland.

Antimicrobial solution (test sample, 2.7 ml) was combined with inoculums (300 μl) and vortex to achieve good mixing. After determined time point, solution was neutralized with DE (Dey-Engley) broth to stop antimicrobial activity. Neutralized samples were further serial diluted and plated onto 3M Aerobic petrifilm. After incubation, petrifilm plates were counted and number of surviving microorganisms expressed in colony forming units (CFU) estimated. Test control was prepared by combining Butterfield's phosphate buffer with inoculums and carried out in the same manner as a test sample.

### Test Results

Table 1 lists the compositions for a tablet (Comparative Ex-01) and powders (Ex-02 and Ex-03). The tablet (Comparative Ex-01) (40 g) was dissolved in 4-liter water for 10 or 20 minutes.

TABLE 1
Solid Effervescent Cleaning Compositions

| | Comp. Ex-01 | Ex-02 | Ex-03 |
|---|---|---|---|
| Component | % | % | % |
| Sodium Carbonate | 23 | 24 | 23.4 |
| PEG 400 | 0.3 | 0 | 0 |
| Blue Dye (erioglaucine | 0.01 | 0 | 0 |
| disodium salt) | | | |
| Lemon Fragrance | 0.3 | 0 | 0 |
| Sodium Metabisulfite | 0.06 | 0 | 0 |
| Sodium Lauryl Sulfate | 1.5 | 1.4 | 1.4 |
| Sodium Lauryl sulfoacetate | 2.5 | 2.3 | 2.3 |
| Silicon Dioxide, Chemically | 0.5 | 0.4 | 0.4 |
| Prepared | | | |
| Calcium Sulfate Hemihydrate | 5 | 4.6 | 4.5 |
| Sodium Benzoate | 0 | 4.4 | 4.4 |
| Thymol | 0 | 0 | 2 |
| Caprylyl glycol | 0 | 4 | 4 |
| Citric acid | 12 | 42.5 | 41.6 |
| Sulfamic acid | 49.83 | 16.4 | 16 |
| PEG 6000 | 5.0 | 0 | 0 |
| pH | 2.20 | 4.09 | 4.18 |

TABLE 2
Compositions of Effervescent Powders

| | EX-04 | EX-05 | Ex-06 |
|---|---|---|---|
| Component | % | % | % |
| PEG 400 | 0.30 | 0.30 | 0.30 |
| SunFast Green 7 | 0.03 | 0.03 | 0.03 |
| Sodium metabisulfite | 0.06 | 0.06 | 0.06 |
| Soda Ash | 23.00 | 23.00 | 25.50 |
| SZ41894 | 0.30 | 0.30 | 0.30 |
| Stepanol ® WA-100 NF/USP | 1.50 | 1.50 | 1.50 |
| Lathanol ® LAL | 2.50 | 2.50 | 2.50 |
| Sipernat ® 50S | 0.50 | 0.50 | 1.00 |
| No. 1 Molding Plaster | 5.00 | 5.00 | 5.00 |
| Sulfamic Acid | 13.00 | 13.00 | 0.00 |
| Citric Acid | 42.00 | 42.00 | 52.00 |
| PEG 4600 | 5.00 | 5.00 | 5.00 |
| Caprylyl Glycol | 1.00 | 0.00 | 1.00 |
| Sodium Benzoate | 3.81 | 3.81 | 3.81 |
| Thymol | 2.00 | 3.00 | 2.00 |
| pH | 4.24 | 4.12 | 4.67 |

TABLE 3
Antibacterial activity (Log Reduction)

| | | | Powder | | | |
|---|---|---|---|---|---|---|
| | | | in Water | Contact | | |
| | Weight | Water | Time | Time | | |
| | (g) | (g) | (min) | (min) | S. aures | E. Coli |
| Comp. | 40 | 4000 | 10 | 1 | 4.59 | 6.28 |
| Ex-01 | | | | | | |
| Comp. | 40 | 4000 | 20 | 1 | 5.83 | 6.23 |
| Ex-01 | | | | | | |
| Ex-02 | 20 | 2000 | 10 | 10 | 6.53 | 1.35 |
| Ex-03 | 20 | 2000 | 10 | 1 | 3.25 | 4.56 |
| Ex-03 | 20 | 2000 | 10 | 10 | 6.53 | 6.60 |
| Ex. 04 | 20 | 1000 | 20 | 1 | 5.54 | 5.50 |
| Ex. 04 | 20 | 2000 | | 1 | 3.67 | 2.20 |
| Ex. 04 | 20 | 2000 | | 5 | 5.95 | 6.39 |
| Ex. 05 | 20 | 1000 | | 1 | 6.26 | 5.82 |
| Ex. 05 | 20 | 2000 | | 1 | 3.10 | 0.95 |
| Ex. 05 | 20 | 2000 | | 5 | 4.94 | 6.39 |
| Ex. 6 | 20 | 1000 | | 1 | 5.92 | 5.46 |
| Ex. 6 | 20 | 2000 | | 5 | 5.92 | 6.47 |

As shown in Table 3, Comparative Ex-01 with a sufficiently low pH demonstrated very effective antimicrobial kills for both Gram (+) and Gram (−) bacterial (1 minute contacting time). However, at higher pH, gram (−) bacteria, such as E. coli is not effectively killed in the absence of an antimicrobial agent.

TABLE 4A
Examples Comprising Acrylic Polymer

| | Ex-7 | Ex-8 | Comp. Ex-9 |
|---|---|---|---|
| Component | % | % | % |
| Soda Ash | 23 | 23 | 25 |
| SunFast Green 7 | 0.02 | 0.02 | 0.02 |
| SZ41894 | 0.3 | 0.3 | 0.3 |
| Stepanol WA-100 | 1.5 | 1.5 | 1.5 |
| Lathanol LAL | 2.5 | 2.5 | 2.5 |
| Sipernat ® 50S | 0.5 | 0.5 | 0.5 |
| No. 1 Molding Plaster | 5 | 3 | 5 |
| Sulfamic Acid | 0 | 0 | 0 |
| Citric Acid | 52.68 | 52.68 | 55.18 |
| PEG 4600 | 5 | 4 | 5 |
| Sodium Benzoate | 4 | 4 | 0 |
| Thymol | 0 | 3 | 0 |
| Caprylyl Glycol | 0.5 | 0.5 | 0 |
| Mirapol Surf-S 900 (Solid) | 5 | 5 | 5 |
| pH | 4.48 | 4.46 | 4.45 |

TABLE 4B
Examples Comprising Acrylic Polymer

| | Comp. Ex. 10 | Ex. 11 |
|---|---|---|
| Component | % | % |
| Citric Acid | 44.5 | 43.5 |
| Sodium Bicarbonate | 40 | 39 |
| Stepan Me-Dry | 4 | 4 |
| Corn Starch | 1.5 | 0.5 |
| Sipernat 50S | 0.5 | 0.5 |
| Sodium Benzoate | 4.5 | 4 |
| Thymol | 0 | 3 |
| Caprylyl Glycol | 0 | 0.5 |
| Mirapol Surf-S 900 (Solid) | 5 | 5 |
| pH | 5.37 | 5.2 |

TABLE 5
Antibacterial activity (Log Reduction)—Weight of
solid cleaning composition = 20 g, 2000 g
water, contact time 5 min.

| | S. aureus | E. Coli |
|---|---|---|
| Ex-7 | 5.19 | 0.70 |
| Ex-8 | 5.19 | 5.46 |
| Comp. Ex-9 | 5.19 | 0.42 |
| Comp. Ex-10 | 5.19 | 1.55 |
| Ex-11 | 5.19 | 4.94 |

For the compositions of Table 6A, a bottle with the dry formulation components was shaken for 30 min to make sure the solid powder was mixed. Powder (40 g) was combined with 160 g of DI water to prepare a master solutions. Master solution was stirred for 45 min before antimicrobial assay.

TABLE 6A
Compositions of Effervescent Powders

| | Comp | Comp | | | | | |
|---|---|---|---|---|---|---|---|
| | Ex 12 | Ex 13 | Ex-14 | Ex-15 | Ex-16 | Ex-17 | Ex-18 |
| Citric Acid (CA) | 44.5 | 44.5 | 44.5 | 44.5 | 44.5 | 44.5 | 44.5 |
| Sodium Bicarbonate | 40 | 40 | 40 | 40 | 40 | 40 | 40 |
| Corn Starch | 5.25 | 3.75 | 0.55 | 1.65 | 2.25 | 1.55 | 1.6 |
| Sipernat 50S | 5.25 | 3.75 | 0.55 | 1.65 | 2.25 | 1.55 | 1.6 |
| Stepanol Me-Dry | 5 | 5 | 10 | 5 | 5 | 5 | 5 |
| Sodium Benzoate | 0 | 3 | 3 | 3 | 3 | 3 | 3 |
| Capmul 908P | 0 | 0 | 1.4 | 4.2 | 0 | 1.4 | 0 |
| Caprylyl Glycol | 0 | 0 | 0 | 0 | 3 | 3 | 0 |
| Preventol O Extra | 0 | 0 | 0 | 0 | 0 | 0 | 4.3 |

The solution for antimicrobial efficacy test is prepared by diluting 10 mL of a master solution with 18 mL of water. The amount of antimicrobial in the diluted solution is reported in the following Table 6B.

TABLE 6B
Diluted Compositions of Effervescent Tablet and Powders

| | Comp. | Comp. | | | | | |
|---|---|---|---|---|---|---|---|
| | Ex 12 | Ex. 13 | Ex-14 | Ex-15 | Ex-16 | Ex-17 | Ex-18 |
| Dilution Factor | 2.8 | 2.8 | 2.8 | 2.8 | 2.8 | 2.8 | 2.8 |
| CARV (%) | 1.0017 | 1.0017 | 1.0017 | 1.0017 | 1.0017 | 1.0017 | 1.0017 |
| Mole Ratio (NaHCO₃/CA) | 2.05 | | | | | | |
| Capmul 908P (%) | 0 | 0 | 0.1 | 0.3 | 0 | 0.1 | 0 |
| Caprylyl Glycol (%) | 0 | 0 | 0 | 0 | 0.21 | 0.21 | 0 |
| Preventol O Extra (%) | 0 | 0 | 0 | 0 | 0 | 0 | 0.31 |
| pH | | 5.03 | | 5.08 | | | |

TABLE 7
Antibacterial activity (Log Reduction)

| | S. aureus | | | E. coli | | |
|---|---|---|---|---|---|---|
| | 1 min | 2 min | 10 min | 1 min | 2 min | 10 min |
| Comp. 12 | 6.01 | n/a | 5.86 | 0.13 | n/a | 0.18 |
| Comp. 13 | 6.17 | 5.88 | n/a | 0.05 | 0.09 | n/a |
| Ex-14 | 5.76 | 5.28 | n/a | 0.08 | 0.18 | 5.19 |
| Ex-15 | n/a | n/a | n/a | 4.82 | 6.24 | 6.24 |
| Ex-16 | 6.01 | n/a | 6.01 | 2.15 | n/a | 6.25 |
| Ex-17 | 4.87 | 6.03 | n/a | 5.89 | 6.00 | n/a |
| Ex-18 | 6.17 | 6.12 | n/a | 6.30 | 6.30 | n/a |

1. A solid effervescent cleaning composition comprising:
one or more acids;
a gas generator;
wherein a 1 wt. % aqueous solution of the solid cleaning composition has a pH in a range of 4 to 9; and
at least one antimicrobial compound.

2. The solid effervescent cleaning composition of claim 1 wherein a 1 wt. % aqueous solution of the solid effervescent cleaning composition provides at least a 3 log reduction for both gram position and gram negative bacteria.

3. The solid effervescent cleaning composition of claim 1 wherein in the absence of the antimicrobial compound a 1 wt. % aqueous solution of the solid effervescent cleaning composition does not provides at least a 3 log reduction for gram negative bacteria.

4. The solid effervescent cleaning composition of claim 1 wherein the antimicrobial compound is selected from aromatic alcohols; aliphatic alcohols, optionally further comprising an ester moiety; and combinations thereof.

5. The solid effervescent cleaning composition of claim 1 where the acid comprises a weak acid.

6. The solid effervescent cleaning composition of claim 1 where the weak acid is citric acid.

7. The solid effervescent cleaning composition of claim 1 where the acid comprises a strong acid.

8. The solid effervescent cleaning composition of claim 7 wherein the strong acid is sulfamic acid.

9. The solid effervescent cleaning composition of claim 1 wherein the at least one antimicrobial compound has a water solubility less than 10 g/liter at 25° C.

10. The solid effervescent cleaning composition of claim 1 wherein the solid effervescent cleaning composition is a powder optionally provided in a water-soluble pouch or pod.

11. The solid effervescent cleaning composition of claim 1 wherein the solid effervescent cleaning composition is a tablet.

12. The solid effervescent cleaning composition of claim 1 wherein the solid effervescent cleaning composition further comprises a water soluble acrylic polymer.

13. The solid effervescent cleaning composition of claim 1 wherein the solid effervescent cleaning composition further comprises an organic binder including polyethylene glycol, an inorganic binder, or a combination thereof.

14. The solid effervescent cleaning composition of claim 1 wherein the solid effervescent cleaning composition further comprises additives including fragrance, colorant, surfactant.

15. A woven or nonwoven substrate further comprising the solid effervescent cleaning composition of claim 1.

16. A handle comprising the solid effervescent cleaning composition of claim 1.

17. A handle comprising the woven or nonwoven substrate comprising the solid effervescent cleaning composition of claim 15.
